(19) United States
(12) Patent Application Publication
(10) Pub. No.: US 2025/0264099 A1
(43) Pub. Date: Aug. 21, 2025

(54) FLUID END FOR PUMP

(71) Applicant: SPM Oil & Gas Inc., Fort Worth, TX (US)

(72) Inventors: Johnny Eric DeLeon, II, Arlington, TX (US); Chandu Kumar, Fort Worth, TX (US); Daryl Belshan, Weatherford, TX (US); Adalberto Cortes, Fort Worth, TX (US)

(73) Assignee: SPM Oil & Gas Inc., Fort Worth, TX (US)

(21) Appl. No.: 18/582,735

(22) Filed: Feb. 21, 2024

(51) Int. Cl. F04B 53/16; F16J 15/3284

(52) U.S. Cl. CPC F04B 53/16; F16J 15/3284

(57) ABSTRACT

A fluid end of a pump includes a fluid end body defining a bore extending along a central axis of the fluid end and a first circumferential notch. The fluid end also includes a suction cap received within the bore of the fluid end body and a wear sleeve radially disposed between the fluid end body and the suction cap. The wear sleeve circumferentially surrounds the suction cap and is received within the first circumferential notch of the fluid end body. The wear sleeve is an L-shaped sleeve. An inner surface of the wear sleeve engages with the suction cap. An outer surface of the wear sleeve engages with the fluid end body. The wear sleeve includes a flange portion.

### TECHNICAL FIELD

The present disclosure relates to a pump, and more particularly to, a fluid end of a pump.

### BACKGROUND

A pump, such as a positive displacement pump, is used in hydraulic fracturing operations to pump high-pressure fracturing fluids into wells for recovery of oil and gas trapped in shale formations and the like. Typically, the pump has a power end which is coupled to a diesel engine and transmission that drives the pump. The pump also has a fluid end in which a mix of water, sand, and/or chemicals are pressurized by plungers.

Currently, the fluid end has limited service life due to fatigue crack failures. These failures are a result of operating pressures, mechanical stresses, erosion and corrosion due to contact of high pressure fluids, and the like. Specifically, a primary failure mode of the fluid end is a washed bore of the fluid end that receives a suction cap. The bore where a suction cover seal is disposed experiences excessive wear from wash boarding of seals and applied pressure. Damage to seals causes leakages within the fluid end. The fluid end needs to be weld repaired and re-machined to return the fluid end to service, which may increase operating costs associated with the pump. Further, the seals disposed in the fluid end may also have to be replaced, thereby incurring additional operating costs.

U.S. Pat. No. 9,739,130 describes a fluid end for high pressure reciprocating pump, in particular for hydraulic fracturing pumps, comprising: a body having a first bore for receiving a reciprocating plunger, a second bore for accommodating a suction valve, and a third bore for accommodating a discharge valve, the second bore and the third bore being perpendicular to the first bore; at least a tubular sleeve in said first bore; at least a tubular cartridge in the second bore and/or third bore; and a fluid tight seal between contacting surfaces of said sleeve and said cartridge.

### SUMMARY OF THE DISCLOSURE

In an aspect of the present disclosure, a fluid end of a pump is provided. The fluid end includes a fluid end body defining a bore extending along a central axis of the fluid end and a first circumferential notch extending along the central axis and in communication with the bore. A first axial length of the bore is greater than a second axial length of the first circumferential notch. The fluid end also includes a suction cap received within the bore of the fluid end body. The fluid end includes a wear sleeve radially disposed between the fluid end body and the suction cap. The wear sleeve circumferentially surrounds the suction cap. The wear sleeve is received within the first circumferential notch of the fluid end body. The wear sleeve is an L-shaped sleeve that defines a first end, a second end opposite the first end along the central axis, an inner surface extending from the first end to the second end, and an outer surface disposed opposite the inner surface and extending from the first end to the second end. The inner surface of the wear sleeve engages with the suction cap. The outer surface of the wear sleeve engages with the fluid end body. The wear sleeve includes a flange portion.

In another aspect of the present disclosure, a fluid end of a pump is provided. The fluid end includes a fluid end body defining a bore extending along a central axis of the fluid end and a first circumferential notch extending along the central axis and in communication with the bore. A first axial length of the bore is greater than a second axial length of the first circumferential notch. The fluid end also includes a suction cap received within the bore of the fluid end body. The suction cap defines a circumferential groove at an outer surface thereof. The fluid end further includes a tubular sleeve radially disposed between the fluid end body and the suction cap. The tubular sleeve circumferentially surrounds the circumferential groove of the suction cap. The tubular sleeve is received within the first circumferential notch of the fluid end body. The fluid end includes a sealing element disposed within the circumferential groove of the suction cap and engaging with the tubular sleeve.

Other features and aspects of this disclosure will be apparent from the following description and the accompanying drawings.

### BRIEF DESCRIPTION OF THE DRAWINGS

FIG. 1 is a schematic sectional view of an exemplary pump;

FIG. 2 is a schematic sectional view illustrating a portion of a fluid end for the pump of FIG. 1;

FIG. 3A is a schematic perspective view of a wear sleeve of the fluid end of FIG. 2;

FIG. 3B is a schematic sectional view of the wear sleeve of FIG. 3A;

FIG. 4 is a schematic sectional view illustrating a portion of a fluid end for the pump of FIG. 1;

FIG. 5A is a schematic perspective view of a tubular sleeve of the fluid end of FIG. 4; and

FIG. 5B is a schematic sectional view of the wear sleeve of FIG. 5A.

### DETAILED DESCRIPTION

Wherever possible, the same reference numbers will be used throughout the drawings to refer to the same or like parts.

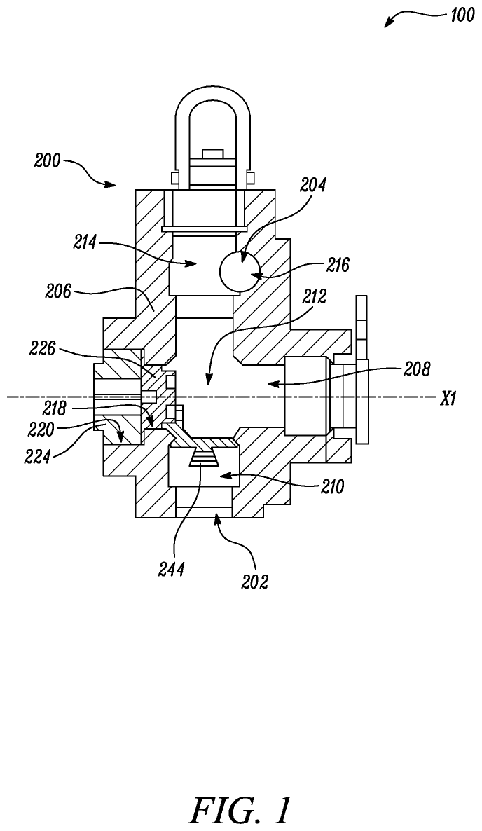

Referring to FIG. 1, a schematic sectional view of a fluid end 200 of a pump 100 is illustrated. The pump 100 may include any type of positive displacement pump. In an example, the pump 100 may include a reciprocating pump. Further, the pump 100 may be used in well stimulation arrangements as a hydraulic fracturing pump to pressurize high pressure fracturing (fracking) fluids into wells for recovery of oil and gas trapped in shale formations and the like. Alternatively, the pump 100 may be usable for other applications.

The pump 100 typically includes a power end (not shown), driven by a diesel engine and transmission, which is coupled to the fluid end 200 that is supplied with the fracking fluid containing water and other ingredients. The fluid end 200 receives the fracking fluid via an inlet 202. Further, the fracking fluid is pressurized in the fluid end 200 and discharged through an outlet 204.

The fluid end 200 includes a fluid end body 206. In an example, the fluid end body 206 may be made of stainless steel. The fluid end body 206 defines a plunger bore 208, a suction bore 210, a center chamber 212 for pressurization of the fracking fluid, and a discharge bore 214. The discharge bore 214 feeds into a discharge passage 216 through which high pressure fracking fluid leaves the fluid end body 206. The fluid end 200 includes a suction check valve (not shown) and a suction valve spring retainer 244 disposed proximal to the inlet 202. Further, the fluid end 200 may include a discharge check valve (not shown) proximal to the discharge passage 216.

The fluid end 200 also includes a plunger (not shown) received in the plunger bore 208. The plunger reciprocates to effect pressurization in the center chamber 212 to allow the fracking fluid therein, at low pressure from the suction bore 210. Correspondingly, the discharge bore 214 receives the pressurized fracking fluid from the center chamber 212 and discharges the same into the discharge passage 216.

Further, the fluid end body 206 also defines a bore 218 extending along a central axis X1 of the fluid end 200. As shown, an access opening 220 in communication with the bore 218 receives a removable, retaining nut 224 to provide selective access to the interior of the fluid end body 206. The fluid end 200 also includes a suction cap 226 received within the bore 218 of the fluid end body 206. The suction cap 226 is disposed to close off and isolate the center chamber 212 to prevent fluid flow-out through the bore 218 and the access opening 220. The suction cap 226 has a stepped design herein. Further, the retaining nut 224 and the suction cap 226 may be removed to service components, such as, the suction check valve (not shown) and the plunger (not shown) disposed in the fluid end 200. The suction cap 226 defines a circumferential groove 228 at an outer surface 230 thereof.

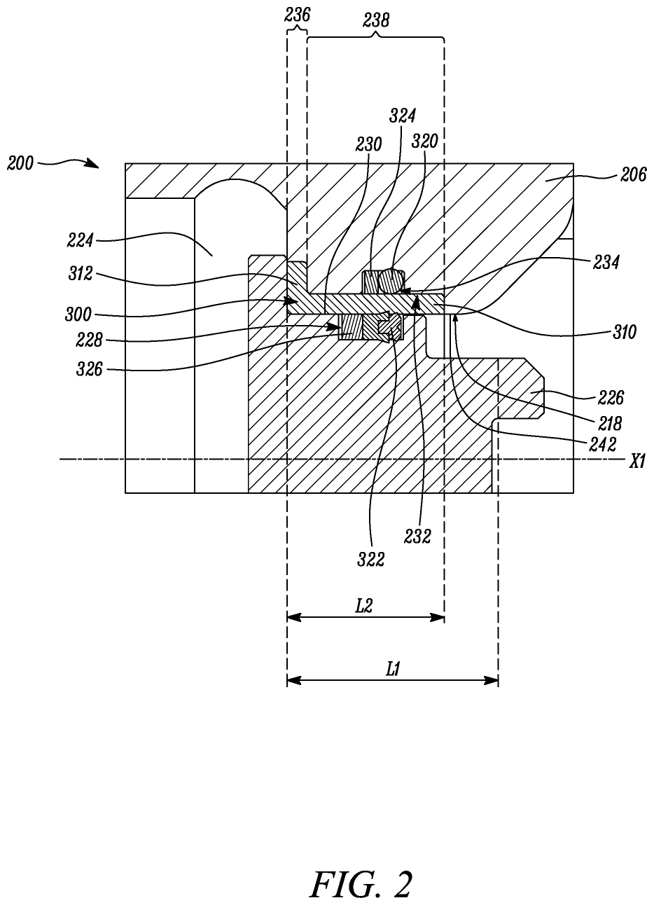

Referring to FIG. 2, the fluid end body 206 defines a first circumferential notch 232 extending along the central axis X1 and in communication with the bore 218. In some embodiments, the fluid end body 206 may define a second circumferential notch 234 in communication with the first circumferential notch 232 and the bore 218. The second circumferential notch 234 may be used for disposition of a first sealing element 320 and a second sealing element 322. However, the second circumferential notch 234 is optional as described in detail below. The bore 218 defines a first axial length L1 and the first circumferential notch 232 defines a second axial length L2. The first axial length L1 of the bore 218 is greater than the second axial length L2 of the first circumferential notch 232. In one embodiment, the first circumferential notch 232 defines a first notch portion 236 and a second notch portion 238, thus the first circumferential notch 232 is an L-shaped notch.

The fluid end 200 also includes a wear sleeve 300 radially disposed between the fluid end body 206 and the suction cap 226. The wear sleeve 300 circumferentially surrounds the suction cap 226. The wear sleeve 300 is disposed such that the wear sleeve 300 circumferentially surrounds the circumferential groove 228 of the suction cap 226. Further, the wear sleeve 300 is received within the first circumferential notch 232 of the fluid end body 206. The wear sleeve 300 is made of a metallic material having a hardness value of at least 40 C on the Rockwell Scale of Hardness. The wear sleeve 300 may be made of a material that demonstrates anti-wear properties such as, toughness, hardness, and/or material consistency. In an example, the wear sleeve 300 may be made of steel. In some examples, the wear sleeve 300 may have a coating that demonstrates anti-wear properties such as, toughness, hardness, and/or material consistency. In certain implementations, the material composition, hardness value, anti-wear properties, and/or coating of the wear sleeve 300 can provide advantages that are needed to overcome one or more problems in the industry that are associated with fluid ends of hydraulic fracturing pumps. In an example, the wear sleeve 300 may be coupled with the pump 100 body via an interference fit that forms a metal to metal seal. Further, in an example, the wear sleeve 300 may be coupled with the suction cap 226 via a slip fit or a clearance fit.

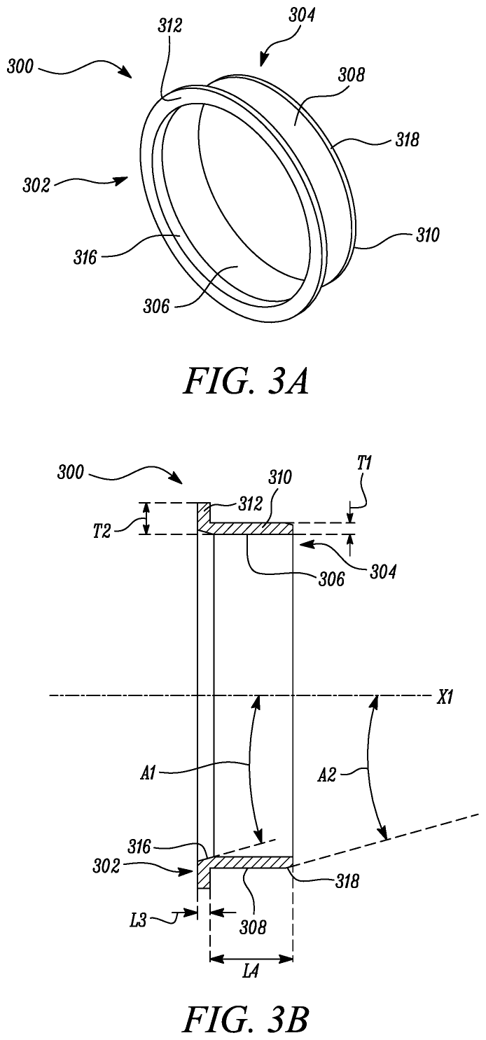

Referring to FIGS. 2, 3A, and 3B, the wear sleeve 300 is an L-shaped sleeve that defines a first end 302. The wear sleeve 300 also defines a second end 304 opposite the first end 302 along the central axis X1. The wear sleeve 300 further defines an inner surface 306 extending from the first end 302 to the second end 304. The wear sleeve 300 defines an outer surface 308 disposed opposite the inner surface 306. The outer surface 308 extends from the first end 302 to the second end 304. The inner surface 306 of the wear sleeve 300 engages with the suction cap 226. Further, in some examples, the inner surface 306 of the wear sleeve 300, at the second end 304, is coplanar with an inner surface 242 of the bore 218 that is axially adjacent to the first circumferential notch 232. Moreover, the outer surface 308 of the wear sleeve 300 engages with the fluid end body 206.

The wear sleeve 300 includes a flange portion 312. The flange portion 312 is disposed at the first end 302 and extends perpendicular to the central axis X1. The flange portion 312 is received within the first notch portion 236.

The wear sleeve 300 also includes a tubular portion 310 extending from the second end 304 towards the first end 302. The tubular portion 310 is integral with the flange portion 312. The tubular portion 310 is received within the second notch portion 238.

As shown in FIG. 3B, in an example, an aspect ratio of a thickness T1 of the tubular portion 310 to a thickness T2 of the flange portion 312 lies in a range between ¼ and ½. Further, the flange portion 312 defines an axial length L3 and the tubular portion 310 defines an axial length L4. The axial length L4 of the tubular portion 310 is greater than the axial length L3 of the flange portion 312. In an example, a ratio of the axial length L3 of the flange portion 312 to the axial length L4 of the tubular portion 310 lies in a range between 0.1 and 0.2. In certain implementations, one or more of the dimensional characteristics of the wear sleeve 300 listed above can provide advantages that are needed to achieve proper form, fit, and function of the part.

Further, the inner surface 306 of the wear sleeve 300 includes a first chamfered surface 316 proximal to the first end 302 of the wear sleeve 300. The first chamfered surface 316 is disposed at an angle Al between 8 degrees and 30 degrees relative to the central axis X1. In an example, the angle A1 of the first chamfered surface 316 relative to the central axis X1 is equal to 15 degrees.

Further, the outer surface 308 of the wear sleeve 300 includes a second chamfered surface 318 proximal to the second end 304 of the wear sleeve 300. Thus, the outer surface 308 includes a step profile created by the flange portion 312 and the tubular portion 310 of the wear sleeve 300, and also includes the second chamfered surface 318. The second chamfered surface 318 is disposed at an angle A2 between 8 degrees and 30 degrees relative to the central axis X1. In an example, the angle A2 of the second chamfered surface 318 relative to the central axis X1 is equal to 15 degrees. In certain implementations, one or more of the angular characteristics of the wear sleeve 300 listed above can provide advantages that are needed to achieve proper form, fit, and function of the part.

Referring now to FIG. 2, the fluid end 200 also includes the first sealing element 320 disposed within the second circumferential notch 234. The first sealing element 320 engaging with the wear sleeve 300. In an example, the first sealing element 320 is an O-ring herein. As described above, the second circumferential notch 234 is optional. For example, the second circumferential notch 234 may be omitted, and a metal to metal seal may be defined between the outer surface 308 of the wear sleeve 300 and an opposing inner surface of the bore 218 (e.g., within the first circumferential notch 232).

Further, the fluid end 200 includes the second sealing element 322 disposed within the circumferential groove 228 defined at the outer surface 230 of the suction cap 226. The second sealing element 322 may be interchangeably referred to as “sealing element” in this disclosure. The second sealing element 322 engages with the wear sleeve 300. The first sealing element 320 and the second sealing element 322 are disposed on opposite sides of the wear sleeve 300. In an example, the second sealing element 322 is a lip seal.

The fluid end 200 further includes a first back-up ring 324 disposed within the second circumferential notch 234. The first back-up ring 324 and the first sealing element 320 are disposed adjacent to each other. Further, the first back-up ring 324 and the first sealing element 320 may be designed to withstand a pressure of up to 15 Kips per square inch (ksi) and may withstand operation at −40 to 175 degrees Fahrenheit. Moreover, the fluid end 200 includes a second back-up ring 326 disposed within the circumferential groove 228 of the suction cap 226. The second back-up ring 326 and the second sealing element 322 are disposed adjacent to each other.

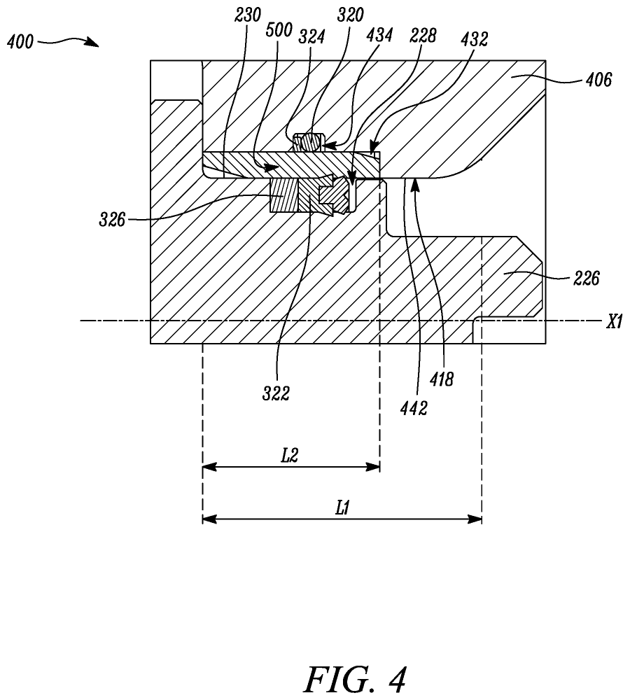

FIG. 4 illustrates another design for a fluid end 400 of the pump 100 of FIG. 1. The fluid end 400 is substantially similar to the fluid end 200 described in relation to FIG. 2. Identical components will be referred using the same numbers. The fluid end 400 includes a fluid end body 406. The fluid end body 406 defines a bore 418 extending along a central axis X1 of the fluid end 400. The fluid end 400 also includes the suction cap 226 received within the bore 418 of the fluid end body 406. The suction cap 226 defines the circumferential groove 228 at the outer surface 230 thereof.

The fluid end body 406 defines a first circumferential notch 432 extending along the central axis X1 and in communication with the bore 418. In some embodiments, the fluid end body 406 may define a second circumferential notch 434 in communication with the first circumferential notch 432 and the bore 418. The second circumferential notch 434 may be used for disposition of the first sealing element 320 and the second sealing element 322. However, the second circumferential notch 434 is optional as described in detail below. The bore 418 defines a first axial length L1 and the first circumferential notch 432 defines a second axial length L2. The first axial length L1 of the bore 418 is greater than the second axial length L2 of the first circumferential notch 432.

The fluid end 400 also includes a tubular sleeve 500 radially disposed between the fluid end body 406 and the suction cap 226. The tubular sleeve 500 circumferentially surrounds the circumferential groove 228 of the suction cap 226. Further, the tubular sleeve 500 is received within the first circumferential notch 432 of the fluid end body 406. The tubular sleeve 500 is made of a metallic material having a hardness value of at least 40 C on the Rockwell Scale of Hardness. In an example, the tubular sleeve 500 may be made of steel. In some examples, the tubular sleeve 500 may have a coating that demonstrates anti-wear properties such as, toughness, hardness, and/or material consistency. The tubular sleeve 500 may be made of a material that demonstrates anti-wear properties such as, toughness, hardness, and/or material consistency. In certain implementations, the material composition, hardness value, anti-wear properties, and/or coating of the wear sleeve 500 can provide advantages that are needed to overcome one or more problems in the industry that are associated with fluid ends of hydraulic fracturing pumps. In an example, the tubular sleeve 500 may be coupled with the pump 100 body via an interference fit that forms a metal to metal seal. Further, in an example, the tubular sleeve 500 may be coupled with the suction cap 226 via a slip fit or a clearance fit.

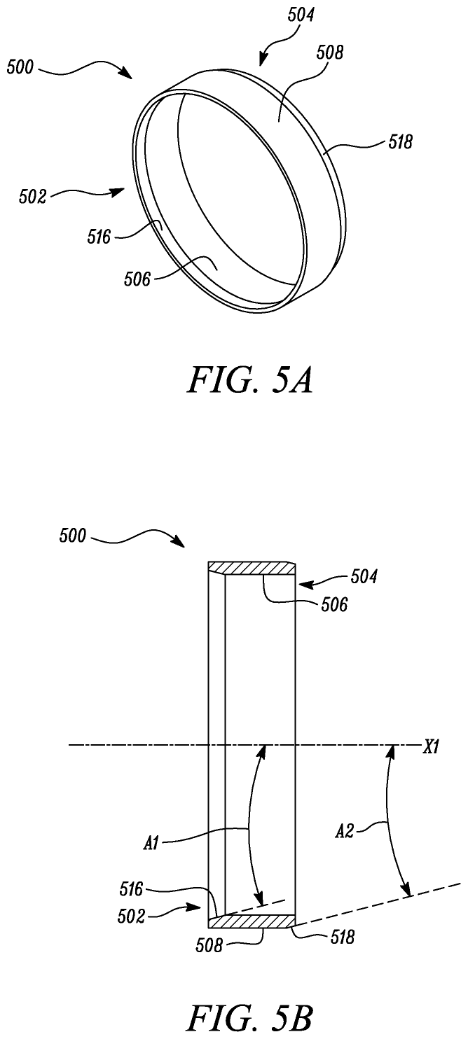

Referring to FIGS. 4, 5A, and 5B, the tubular sleeve 500 defines a first end 502. The tubular sleeve 500 also defines a second end 504 opposite the first end 502 along the central axis X1. The tubular sleeve 500 further defines an inner surface 506 extending from the first end 502 to the second end 504. The tubular sleeve 500 defines an outer surface 508 disposed opposite the inner surface 506. The outer surface 508 extends from the first end 502 to the second end 504. The inner surface 506 of the tubular sleeve 500 engages with the suction cap 226. Further, the inner surface 506 of the tubular sleeve 500, at the second end 504, is coplanar with an inner surface 442 of the bore 418 that is axially adjacent to the first circumferential notch 432. Moreover, the outer surface 508 of the tubular sleeve 500 engages with the fluid end body 406 to form a metal to metal seal.

As shown in FIG. 5B, the inner surface 506 of the tubular sleeve 500 includes a first chamfered surface 516 proximal to the first end 502 of the tubular sleeve 500. The first chamfered surface 516 is disposed at an angle between 8 degrees and 30 degrees relative to the central axis X1. In an example, the angle of the first chamfered surface 516 relative to the central axis X1 is equal to 15 degrees.

Further, the outer surface 508 of the tubular sleeve 500 includes a second chamfered surface 518 proximal to the second end 504 of the tubular sleeve 500. The second chamfered surface 518 is disposed at an angle between 8 degrees and 30 degrees relative to the central axis X1. In an example, the angle of the second chamfered surface 518 relative to the central axis X1 is equal to 15 degrees. In certain implementations, one or more of the angular characteristics of the wear sleeve 500 listed above can provide advantages that are needed to achieve proper form, fit, and function of the part.

Referring again to FIG. 4, the fluid end 400 also includes the first sealing element 320 disposed within the second circumferential notch 434, the second sealing element 322 disposed within the circumferential groove 228 of the suction cap 226 and engaging with the tubular sleeve 500, the first back-up ring 324 disposed within the second circumferential notch 434, and the second back-up ring 326 disposed within the circumferential groove 228 of the suction cap 226. Each of the first sealing element 320, the second sealing element 322, the first back-up ring 324, and the second back-up ring 326 engage with the tubular sleeve 500. Further, the first sealing element 320 and the sealing element 322 disposed within the circumferential groove 228 of the suction cap 226 are disposed on opposite sides of the tubular sleeve 500. As described above, the second circumferential notch 434 is optional. For example, the second circumferential notch 434 may be omitted, and a metal to metal seal may be defined between the outer surface 508 of the tubular sleeve 500 and an opposing inner surface of the bore 418 (e.g., within the first circumferential notch 432).

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the sleeve 300, 500 associated with the corresponding fluid end 200, 400 for the pump 100. The sleeve 300, 500 has a simple design herein and is retained within the fluid end body 206, 406, for example, by the interference fit. Further, the sleeve 300, 500 includes the first chamfered surface 316, 516 and the second chamfered surface 318, 518 that may simplify an assembly process of the sleeve 300, 500 within the fluid end 200, 400.

The sleeve 300, 500 may prevent/reduce damage to various parts of the fluid end 200, 400, such as, the bore 218, 418, the second sealing element 322, and the second back-up ring 326. In some examples, the sleeve 300, 500 may be embodied as a serviceable/replaceable part, that may be removed from the fluid end 200, 400 in case of damage thereto. Thus, instead of replacing/servicing the entire fluid end 200, 400, only the sleeve 300, 500 may have to be replaced. Further, the sleeve 300, 500 may be made of a material or may have a coating that demonstrates anti-wear properties, such as, toughness, hardness, and/or material consistency. Thus, the sleeve 300, 500 may be less susceptible to wear and tear.

As various parts of the fluid end 200, 400 may be less susceptible to damage, incorporation of the sleeve 300, 500 may reduce maintenance/servicing costs associated with the fluid end 200, 400. Further, the fluid end 200, 400 also includes the first sealing element 320 and the first back-up ring 324 that may withstand pressures up to 15 ksi and withstands operation at −40 to 175 degrees Fahrenheit.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A fluid end of a pump, comprising:
a fluid end body defining a bore extending along a central axis of the fluid end and a first circumferential notch extending along the central axis and in communication with the bore, wherein a first axial length of the bore is greater than a second axial length of the first circumferential notch;
a suction cap received within the bore of the fluid end body; and
a wear sleeve radially disposed between the fluid end body and the suction cap, wherein:
the wear sleeve circumferentially surrounds the suction cap,
the wear sleeve is received within the first circumferential notch of the fluid end body,
the wear sleeve is an L-shaped sleeve that defines a first end, a second end opposite the first end along the central axis, an inner surface extending from the first end to the second end, and an outer surface disposed opposite the inner surface and extending from the first end to the second end,
the inner surface of the wear sleeve engages with the suction cap,
the outer surface of the wear sleeve engages with the fluid end body, and
the wear sleeve includes a flange portion.

2. The fluid end of claim 1, wherein the inner surface of the wear sleeve includes a first chamfered surface proximal to the first end of the wear sleeve, and wherein the first chamfered surface is disposed at an angle between 8 degrees and 30 degrees relative to the central axis.

3. The fluid end of claim 1, wherein the inner surface of the wear sleeve, at the second end, is coplanar with an inner surface of the bore that is axially adjacent to the first circumferential notch.

4. The fluid end of claim 1, wherein the outer surface of the wear sleeve includes a second chamfered surface proximal to the second end of the wear sleeve, and wherein the second chamfered surface is disposed at an angle between 8 degrees and 30 degrees relative to the central axis.

5. The fluid end of claim 1, wherein the fluid end body further defines a second circumferential notch in communication with the first circumferential notch and the bore, and wherein the fluid end further includes a first sealing element disposed within the second circumferential notch and engaging with the wear sleeve.

6. The fluid end of claim 5 further comprising a first back-up ring disposed within the second circumferential notch.

7. The fluid end of claim 5 further comprising:
a second sealing element disposed within a circumferential groove defined at an outer surface of the suction cap and engaging with the wear sleeve, wherein the first sealing element and the second sealing element are disposed on opposite sides of the wear sleeve; and
a second back-up ring disposed within the circumferential groove of the suction cap.

8. The fluid end of claim 1, wherein the wear sleeve is made of a metallic material having a hardness value of at least 40 C on the Rockwell Scale of Hardness.

9. The fluid end of claim 1, wherein the wear sleeve includes a tubular portion extending from the second end towards the first end, and wherein an aspect ratio of a thickness of the tubular portion to a thickness of the flange portion lies in a range between ¼ and ½.

10. The fluid end of claim 9, wherein a ratio of an axial length of the flange portion to an axial length of the tubular portion lies in a range between 0.1 and 0.2.

11. The fluid end of claim 1, wherein the wear sleeve is coupled with the fluid end body via an interference fit that forms a metal to metal seal, and wherein the wear sleeve is coupled with the suction cap via a slip fit or a clearance fit.

12. A fluid end of a pump, comprising:
a fluid end body defining a bore extending along a central axis of the fluid end and a first circumferential notch extending along the central axis and in communication with the bore, wherein a first axial length of the bore is greater than a second axial length of the first circumferential notch;
a suction cap received within the bore of the fluid end body, the suction cap defining a circumferential groove at an outer surface thereof;
a tubular sleeve radially disposed between the fluid end body and the suction cap, wherein the tubular sleeve circumferentially surrounds the circumferential groove of the suction cap, and wherein the tubular sleeve is received within the first circumferential notch of the fluid end body; and
a sealing element disposed within the circumferential groove of the suction cap and engaging with the tubular sleeve.

13. The fluid end of claim 12, wherein the tubular sleeve defines a first end, a second end opposite the first end along the central axis, an inner surface extending from the first end to the second end, and an outer surface disposed opposite the inner surface and extending from the first end to the second end, wherein the inner surface of the tubular sleeve engages with the suction cap, and wherein the outer surface of the tubular sleeve engages with the fluid end body to form a metal to metal seal.

14. The fluid end of claim 13, wherein the inner surface of the tubular sleeve includes a first chamfered surface proximal to the first end of the tubular sleeve, and wherein the first chamfered surface is disposed at an angle between 8 degrees and 30 degrees relative to the central axis.

15. The fluid end of claim 13, wherein the inner surface of the tubular sleeve, at the second end, is coplanar with an inner surface of the bore that is axially adjacent to the first circumferential notch.

16. The fluid end of claim 13, wherein the outer surface of the tubular sleeve includes a second chamfered surface proximal to the second end of the tubular sleeve, and wherein the second chamfered surface is disposed at an angle between 8 degrees and 30 degrees relative to the central axis.

17. The fluid end of claim 12, wherein the fluid end body further defines a second circumferential notch in communication with the first circumferential notch and the bore, and wherein the fluid end further includes:
a first sealing element disposed within the second circumferential notch and engaging with the tubular sleeve, wherein the first sealing element and the sealing element disposed within the circumferential groove of the suction cap are disposed on opposite sides of the tubular sleeve; and
a first back-up ring disposed within the second circumferential notch.

18. The fluid end of claim 12 further comprising a second back-up ring disposed within the circumferential groove of the suction cap.

19. The fluid end of claim 12, wherein the tubular sleeve is made of a metallic material having a hardness value of at least 40 C on the Rockwell Scale of Hardness.

20. The fluid end of claim 12, wherein the tubular sleeve is coupled with the fluid end body via an interference fit that forms a metal to metal seal, and wherein the tubular sleeve is coupled with the suction cap via a slip fit or a clearance fit.
